(19) United States
(12) Patent Application Publication
(10) Pub. No.: US 2026/0117487 A1
(43) Pub. Date: Apr. 30, 2026

(54) WORK MACHINE WITH AN ISOLATOR ASSEMBLY AND SYSTEM

(71) Applicant: Deere & Company, Moline, IL (US)

(72) Inventor: Patrick J. Mulligan, Dubuque, IA (US)

(21) Appl. No.: 18/931,742

(22) Filed: Oct. 30, 2024

(51) Int. Cl. E02F 9/08; B62D 21/02

(52) U.S. Cl. CPC E02F 9/0808; B62D 21/02

(57) ABSTRACT

A work machine with an isolator assembly comprises a main frame defining a central longitudinal axis, and a first and second longitudinal extending track frames pivotally coupled to the main frame on opposing lateral sides of the main frame. The pivotal movement of the first and second track frame relative to the main frame are generally about the central longitudinal axis. A crossbar extending between and substantially transverse to the first and second track frame include a mounting aperture extending in a substantially fore-aft direction. A crossbar pin is disposed within and extends through the mounting aperture. An isolator assembly is coupled to the crossbar pin wherein the isolator assembly interconnects the crossbar and the crossbar pin. The isolator assembly includes an elastomeric isolator, and an actuator selectively controllable between a disengaged position, and an engaged position, for attenuating vibrations generated from track frame movement.

### TECHNICAL FIELD

The disclosure generally relates to a work machine with an isolator assembly coupled to a crossbar, and system.

### BACKGROUND

Work machines, or more specifically crawler type work machines often include a crossbar for a more even distribution of loads applied across the main frame or frame when exposed to vibratory forces from track frames. This can be present in crawler type work machines with an oscillating track frame, wherein the oscillating track frame assists in traversing rough terrain. Conventionally, the work machines include a main frame coupled to a pair of track frames with an endless track chain. Each track frame is pivotally coupled to the main frame to permit the track frame to oscillate relative to the main frame during operation. In some instances, a crossbar is mounted across two sides of the main frame and has its ends pivotally coupled to the track frame so that transverse external loads applied to the forward ends of the track frame are transmitted to the main frame. Generally, this configuration can introduce vibrations making a ride potentially less comfortable for an operator riding in the cab. Therein lies an opportunity for improving the feel during operation by reducing exposure to such vibrations.

### SUMMARY

A work machine with an isolator assembly comprises a main frame defining a central longitudinal axis, and a first and second longitudinal extending track frames pivotally coupled to the main frame on opposing lateral sides of the main frame. The pivotal movement of the first and second track frame relative to the main frame are generally about the central longitudinal axis. A crossbar extending between and substantially transverse to the first and second track frame include a mounting aperture extending in a substantially fore-aft direction. A crossbar pin is disposed within and extends through the mounting aperture. An isolator assembly is coupled to the crossbar pin wherein the isolator assembly interconnects the crossbar and the crossbar pin. The isolator assembly includes an elastomeric isolator, and an actuator selectively controllable between a disengaged position, and an engaged position, for attenuating vibrations generated from track frame movement.

The crossbar is rigidly with the main frame. The mounting aperture is enlarged sufficiently to enabling a two to three degree rotation of the crossbar pin relative to the crossbar.

The elastomeric isolator comprises a first pair of isolator positioned fore of the crossbar wherein the first pair of isolators are coupled to opposing sides of the crossbar pin. A second pair of isolators are positioned aft of the crossbar and the second pair of isolators are also coupled to opposing sides of the crossbar pin.

The actuator comprises of a piston securely coupled to the elastomeric isolator and a cylinder movably coupled to the piston which cooperates with the piston to create a pressurized chamber for a hydraulic fluid. A fluid port for hydraulic ingress and egress to a pressurized fluid line is hydraulically coupled to an accumulator. The actuator also includes a valve coupled to the fluid line and controllable to adjust the pressure in the pressurized chamber.

A controller includes a processor and a memory having a dampening algorithm stored thereon, wherein the processor is operable to execute the dampening algorithm to perform the following. The processor receives a target ride cushioning setting signal from a user input interface, and adjust the pressure in the pressurized chamber based on the target ride cushioning setting signal from the user input interface. The controller further adjusts the pressure in the pressurized chamber based on the pivotal movement of the track frame relative to the main frame. The work machine further comprises a vibration sensor coupled to one of the main frame and the crossbar, wherein the controller further adjusts the pressure in the pressurized chamber based on a vibration output signal from the vibration sensor.

The work machine further comprises a first plate rigidly attached to the crossbar on a first side of the mounting aperture, and a second plate rigidly attached to the crossbar on a second side of the mounting aperture opposite the first plate. The elastomeric isolator is disposed between the first plate and the second plate. The hydraulic actuator is disposed adjacent an opposing side of the first plate relative to the elastomeric isolator. The first plate defines a piston aperture sized to receive a plunger portion of the piston therethrough, wherein the elastomeric isolator is coupled to the plunger portion of the piston. The piston includes a base portion sized larger than the piston aperture and configured to abut the first plate.

Each of the crossbar pin and the second plate define a respective fastener opening, and further comprises a fastener including a head portion disposed adjacent the second plate, and a shank portion extending from the head portion through the fastener opening of the second plate, the fastener opening of the crossbar pin, the piston aperture of the first plate, and engaged with the cylinder portion of the actuator.

The isolator system for attenuating vibrations from a crossbar on the work machine includes a first plate, a second plate, an elastomeric isolator, a crossbar pin, a hydraulic actuator, an accumulator, and a controller. The crossbar includes a mounting aperture. The first plate is rigidly attached to a first side of a mounting aperture on the crossbar. The second plate is rigidly attached to the crossbar on a second side of the mounting aperture opposite the first plate. The elastomeric isolator is disposed between the first plate and the second plate. A crossbar pin is disposed within and extending through the mounting aperture to couple the elastomeric isolator to the crossbar. A hydraulic actuator is disposed adjacent on opposing side of the first plate relative to the elastomeric isolator. An accumulator is hydraulically coupled to the hydraulic actuator. A controller including a processor and a memory having a dampening algorithm stored thereon is operable to execute the dampening algorithm to selectively control engagement of the hydraulic actuator with the accumulator for attenuating vibration on a work machine. The hydraulic actuator includes a piston securely coupled to the elastomeric isolator, and a cylinder movably coupled to the piston and cooperating with the piston to create a pressurized chamber for a hydraulic fluid. The actuator further includes a fluid port for hydraulic fluid ingress and egress to a pressurized fluid line hydraulically coupled to an accumulator; and a valve coupled to the fluid line and controllable to adjust a pressure in the pressurized chamber, wherein the dampening algorithm further controls the hydraulic actuator to adjust a pressure in the pressurized chamber.

The first plate defines a piston aperture sized to receive a plunger portion of the piston therethrough, wherein the elastomeric isolator is coupled to the plunger portion of the piston. The piston includes a base portion sized larger than the piston the piston aperture and configured to abut the first plate.

Each of the crossbar pin and the second plate define a respective fastener opening, and further comprise a fastener including a head portion disposed adjacent the second plate, and a shank portion extending from the head portion through the fastener opening of the second plate, the fastener opening of the crossbar pin, the piston aperture of the first plate, and engaged with the cylinder portion of the actuator.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1A is a perspective view of a work machine with track frame.

FIG. 1B is a top view of a simplified schematic of the work machine with track frames.

FIG. 2 is perspective view of the cross-section of the main frame having an isolator assembly coupled to a crossbar.

FIG. 3 is a perspective view of the isolator assembly.

FIG. 4. is a perspective view of a isolator assembly coupled to the crossbar.

FIG. 5 is a schematic of an isolator system

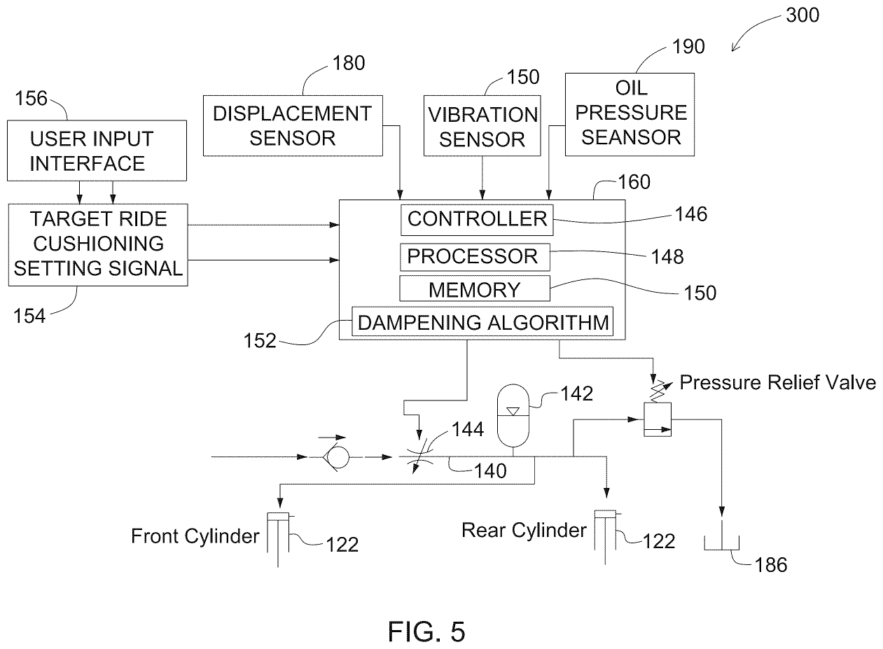

FIG. 6 is a portion of the cross-sectional view of the isolator assembly coupled to a crossbar from FIG. 4 in a disengaged position.

FIG. 7 is a portion of the cross-sectional view of the isolator assembly coupled to a crossbar from FIG. 4 in an engaged position.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

The terms “forward”, “rearward”, “left”, and “right”, when used in connection with a moveable implement and/or components thereof are usually determined with reference to the direction of travel during operation, but should not be construed as limiting. The terms “longitudinal” and “transverse” are usually determined with reference to the fore-and-aft direction of the implement relative to the direction of travel during operation, and should also not be construed as limiting.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

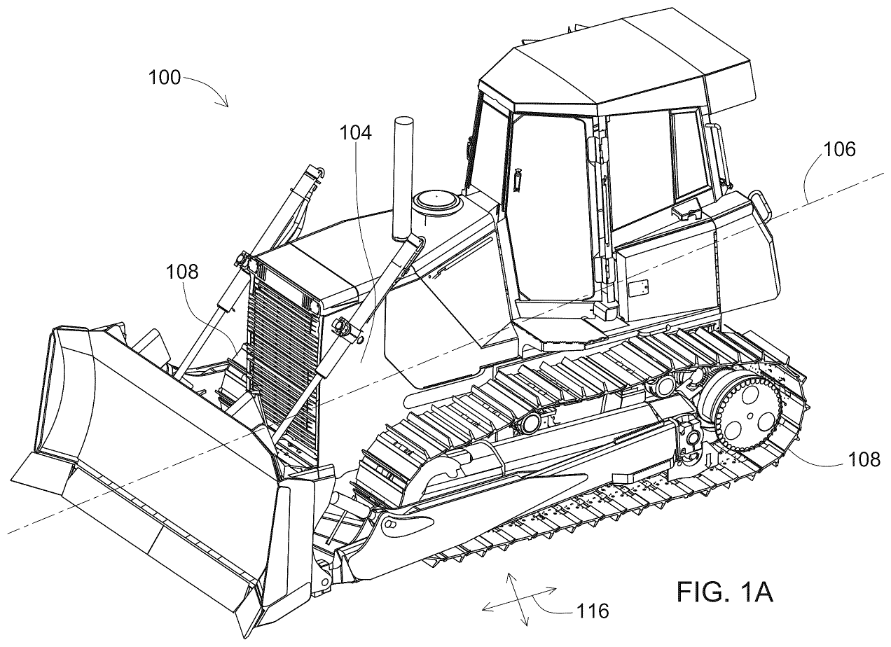

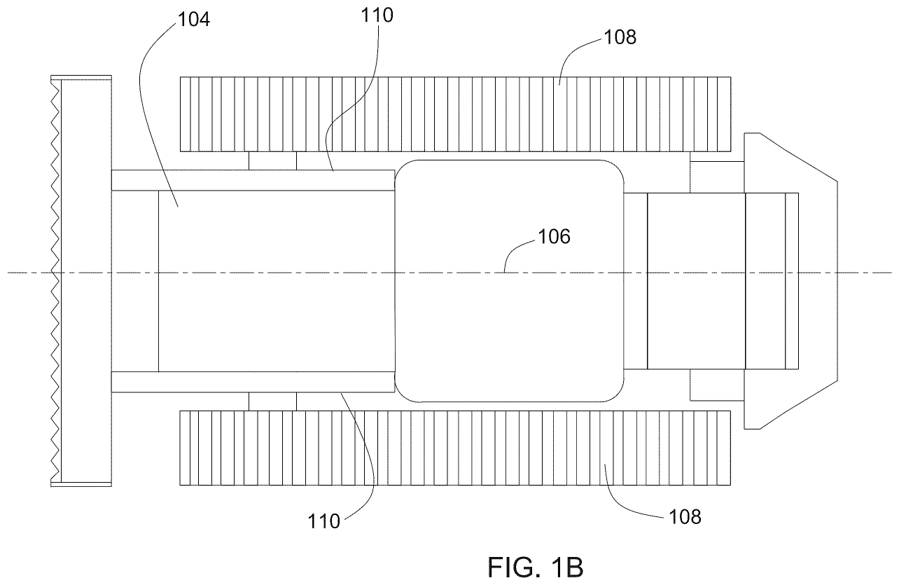

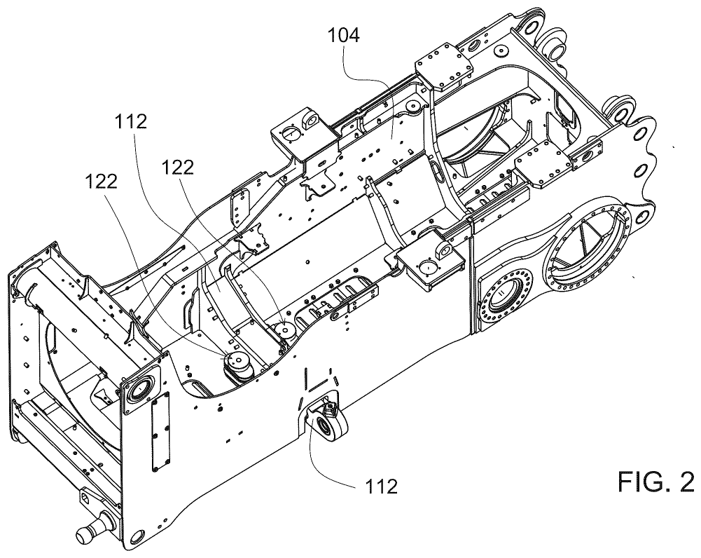

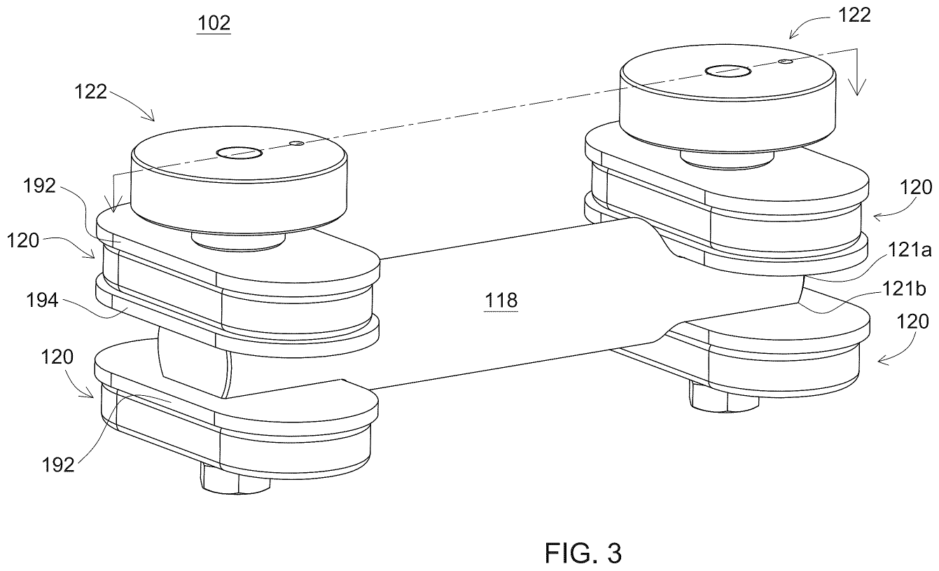

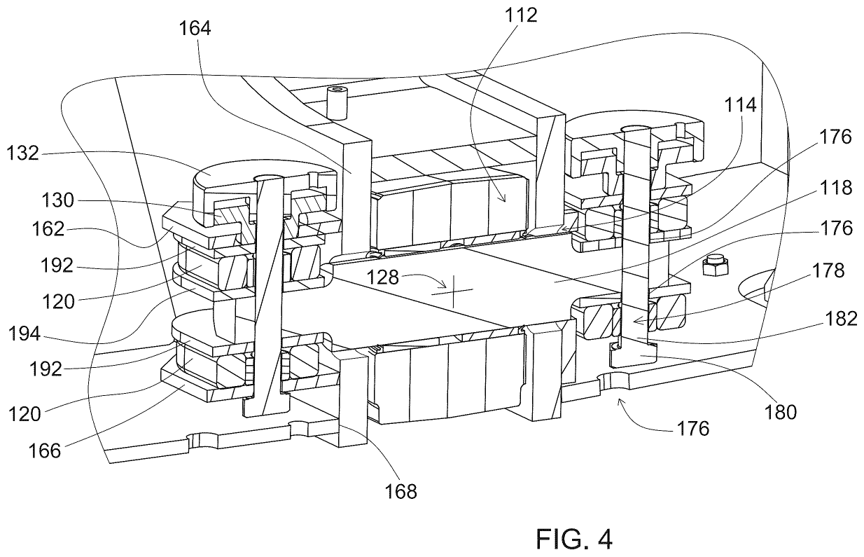

FIGS. 1A and 1B is a work machine 100 with an isolator assembly 102 (also shown in FIGS. 2 and 3) comprising a main frame 104 defining a central longitudinal axis 106, and a first and second longitudinal extending track frames 108 pivotally coupled to the main frame 104 on opposing lateral sides 110 of the main frame 104. The pivotal movement of the first and second track frame 108 relative to the main frame 104 are generally transverse to the central longitudinal axis 106. FIG. 2 shows crossbar 112 extending between and substantially transverse to the first and second track frame 108. The crossbar is fixedly coupled to the main frame 104 and advantageously provides structural support and reinforcement to the main frame 104 thereby enhancing overall stability and load bearing capacity. The crossbar 112 further assists in weight distribution by distributing impacts, shocks, and vibrations encountered during operation, and thereby extending the work machine's longevity. Now turning to FIG. 4, a cross-sectional view of the crossbar 112 is shown alongside with the along with the cross-sectional view of the isolator assembly 102. The crossbar 112 includes a mounting aperture 114 extending in a substantially fore-aft direction 116 wherein the mounting aperture 114 provides a coupling surface of the isolator assembly 102 with the crossbar 112.

Coupling of the isolator assembly 102 with the crossbar advantageously amplifies the vibrational and impact absorption and redistribution capabilities of these components. The isolator assembly 102 absorb and dampen vibrations introduced from driving on rough terrain such as rocks, or uneven surfaces. The following configuration is especially effective in mitigating sudden shocks and thereby contributes to a smoother ride experience for the operator as well. A crossbar pin 118 is disposed within and extends through the mounting aperture 114. The isolator assembly 102 is coupled to the crossbar pin 118 wherein the isolator assembly 102 interconnects the crossbar 112 and the crossbar pin 118. The isolator assembly 102 includes an elastomeric isolator 120, and an actuator 122 selectively controllable between a disengaged position 124 and an engaged position 126, for attenuating vibrations generated from track frame 108 movement.

The crossbar 112 is coupled to the main frame 104. The mounting aperture 114 is enlarged sufficiently to enable a two to three degrees rotation of the crossbar pin 118 relative to the crossbar 112. That is the crossbar pin 118 may pivot about a central axis 128 of the crossbar 112. Alternatively, crossbar pin 118 has just enough “wiggle room” to allow for the transfer of vibrations from the mainframe to the isolator assembly 102.

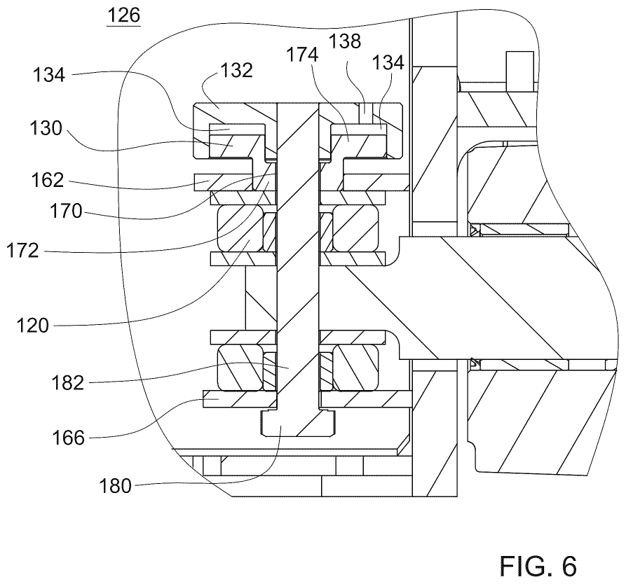

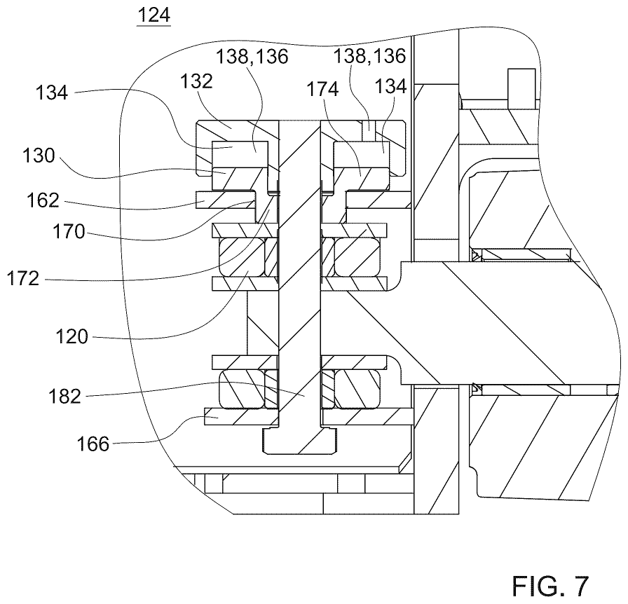

The elastomeric isolator 120 comprises a first pair of isolators 120 positioned fore of the crossbar 112 wherein the first pair of isolators 120 are coupled to opposing sides 121a of the crossbar pin 118. A second pair of isolators 120 are positioned aft of the crossbar 112 and the second pair of isolators 120 are also coupled to opposing sides 121b of the crossbar pin 118. This elastomeric isolator 120 is a type of vibration isolation component that uses elastomeric materials, such as rubber or elastomers, to dampen and isolated vibrations because of its elasticity and flexibility, and overall mechanical response of being compressible. FIG. 7 demonstrates the elastomeric isolators 120 under a greater compression than the elastomeric isolators in FIG. 6 as seen by the vertical height. Furthermore, the elastomeric isolator is resilient and the first form of vibration dissipation of isolator assembly.

The actuator 122 comprises of a piston 130 securely coupled to the elastomeric isolator 120 and a cylinder 132 movably coupled to the piston 130 which cooperates with the piston 130 to create a pressurized chamber 134 for a hydraulic fluid 136. The hydraulic actuator 122 becomes a shock absorber by controlling the hydraulic fluid within the actuator. Shocks and impacts are mitigated as the actuator resists rapid changes in pressure, and thereby provide a cushioning effect. The actuator 122 includes a valve 144 coupled to the fluid line 140 and controllable to adjust the pressure in the pressurized chamber 134. A fluid port 138 for hydraulic ingress and egress to a pressurized fluid line 140 is also hydraulically coupled to an accumulator 142. These built-in dampening components can be adjusted to suit the specific vibration isolation requirements of the terrain, the operation, and the operator's preferences. By fine-tuning the fluid flow and pressure levels the hydraulic actuator can effectively dampen vibrations and provide stability to the system.

A controller 146 includes a processor 148 and a memory 150 having a dampening algorithm 152 stored thereon, wherein the processor 148 is operable to execute the dampening algorithm 152 to perform the following. The processor 148 receives a target ride cushioning setting signal 154 from the user input interface 156 and adjusts the pressure in the pressurized chamber 134 based on the target ride cushioning setting signal 154. In one exemplary embodiment the target ride cushioning setting signal can be adjusted by the operator activating a physical switch (e.g. a slide, roller, or rotary button, or similar, etc.) or a virtual switch (e.g., an icon on a touch screen). Alternatively, the dampening algorithm may automatically enable with passive engagement by only activating when the road and operating conditions warrant such by inputs from a vibration sensor. The work machine 100 may further comprises a vibration sensor 158 coupled to one of the main frame 104 and the crossbar 112, wherein the controller 146 further adjusts the pressure in the pressurized chamber 134 based on a vibration output signal 160 from the vibration sensor 158.

In another embodiment, the controller 146 may further adjusts the pressure in the pressurized chamber 134 based on the pivotal movement of the track frame 108 relative to the main frame 104, wherein the pivotal movement of the track frame 108 relative to the main frame 104 can be sensed by a displacement sensor 188.

The combinatorial impact of executing the dampening algorithm based on one or more variable inputs (i.e. the target ride cushioning setting signal 154, pivotal movement of the track frame 188, and the vibration sensor 160) advantageously accounts for inputs to reflect the optimal vibration dampening level. This fine tune adjustment coupled with the raw dampening effects of the elastomeric isolator 120 creates a multi-faceted approach to attenuating vibrations.

The isolator assembly 102 on the work machine 100 comprises a first plate 162 rigidly attached to the crossbar 112 on a first side 164 of the mounting aperture 114, and a second plate 166 rigidly attached to the crossbar 112 on a second side 168 of the mounting aperture 114 opposite the first plate 162. The elastomeric isolator 120 is disposed between the first plate 162 and the second plate 166. The hydraulic actuator 122 is disposed adjacent an opposing side of the first plate 162 relative to the elastomeric isolator 120. The first plate 162 defines a piston aperture 170 sized to receive a plunger portion 172 of the piston 130 therethrough, wherein the elastomeric isolator 120 is coupled to the plunger portion 172 of the piston 130. The piston 130 includes a base portion 174 sized larger than the piston aperture 170 and configured to abut the first plate 162. A third plate and a fourth plate each are position on opposing sides of the elastomeric isolator. A stop collar limits the degree of compression of the elastomeric isolator when the stop collar abuts both the third plate and the fourth plate. The stop collar is a rigid component positioned around a fastener but along the inner diameter of the elastomeric isolator. The elastomeric isolator coupled 120 with the third plate 192 assembly may be repeated on the opposing side crossbar pin 118, and adjacent to the second plate 166.

Each of the crossbar pin 118 and the second plate 166 define a respective fastener opening 176, and further comprises a fastener 178 including a head portion 180 disposed adjacent the second plate 166, and a shank portion 182 extending from the head portion 180 through the fastener opening 176 of the second plate 166, the fastener opening 176 of the crossbar pin 118, the fastener opening 176 of the third plate 192, the elastomeric isolator 120 and the fourth plate 194, the piston aperture 170 of the first plate 162, and engaged with the cylinder portion 132 of the actuator 122.

The isolator assembly 102 is repeated on the opposing side of the crossbar, creating a front isolator assembly 102 fore of the crossbar and a rear isolator assembly 102 aft of the crossbar 112 to create a balanced isolator system 300. The accumulator 142 are coupled to both the front actuator 122 and the rear actuator 122 through a single fluid line 140.

As described above, the isolator system 300 for attenuating vibrations from a crossbar 112 on the work machine 100 includes a first plate 162, a second plate 166, an elastomeric isolator 120, a crossbar pin 118, a hydraulic actuator 122, an accumulator 142, and a controller 146. The crossbar 112 includes a mounting aperture 114. The first plate 162 is rigidly attached to a first side 164 of a mounting aperture 114 on the crossbar 112. The second plate 166 is rigidly attached to the crossbar 112 on a second side 168 of the mounting aperture 114 opposite the first plate 162. The elastomeric isolator 120 is disposed between the first plate 162 and the second plate 166. A crossbar pin 118 is disposed within and extending through the mounting aperture 114 to couple the elastomeric isolator 120 to the crossbar 112. A hydraulic actuator 122 is disposed adjacent on opposing side of the first plate 162 relative to the elastomeric isolator 120. An accumulator 142 is hydraulically coupled to the hydraulic actuator 122. A controller 146 including a processor 148 and a memory 150 having a dampening algorithm 152 stored thereon is operable to execute the dampening algorithm 152 to selectively control engagement of the hydraulic actuator 122 with the accumulator 142 for attenuating vibration on a work machine 100. The hydraulic actuator 122 includes a piston 130 securely coupled to the elastomeric isolator 120, and a cylinder 132 movably coupled to the piston 130 and cooperating with the piston 130 to create a pressurized chamber 134 for a hydraulic fluid 136. The actuator 122 further includes a fluid port 138 for hydraulic fluid 136 ingress and egress to a pressurized fluid line 140 hydraulically coupled to an accumulator 142; and a valve 144 coupled to the fluid line 140 and controllable to adjust a pressure in the pressurized chamber 134, wherein the dampening algorithm 152 further controls the hydraulic actuator 122 to adjust a pressure in the pressurized chamber 134.

The first plate 162 defines a piston aperture 170 sized to receive a plunger portion 172 of the piston 130 therethrough, wherein the elastomeric isolator 120 is coupled to the plunger portion 172 of the piston 130. The piston 130 includes a base portion 174 sized larger than the piston aperture 170 and configured to abut the first plate 162.

Each of the crossbar pin 118 and the second plate 166 define a respective fastener opening 176, and further comprise a fastener 178 including a head portion 180 disposed adjacent the second plate 166, and a shank portion 182 extending from the head portion 180 through the fastener opening 176 of the second plate 166, the fastener opening 176 of the crossbar pin 118, the piston aperture 170 of the first plate 162, and engaged with the cylinder portion 132 of the actuator 122.

As used herein, “e.g.” is utilized to non-exhaustively list examples, and carries the same meaning as alternative illustrative phrases such as “including,” “including, but not limited to,” and “including without limitation.” As used herein, unless otherwise limited or modified, lists with elements that are separated by conjunctive terms (e.g., “and”) and that are also preceded by the phrase “one or more of,” “at least one of,” “at least,” or a like phrase, indicate configurations or arrangements that potentially include individual elements of the list, or any combination thereof. For example, “at least one of A, B, and C” and “one or more of A, B, and C” each indicate the possibility of only A, only B, only C, or any combination of two or more of A, B, and C (A and B; A and C; B and C; or A, B, and C). As used herein, the singular forms “a”, “an” and “the” are intended to include the plural forms as well, unless the context clearly indicates otherwise. Further, “comprises,” “includes,” and like phrases are intended to specify the presence of stated features, steps, operations, elements, and/or components, but do not preclude the presence or addition of one or more other features, steps, operations, elements, components, and/or groups thereof.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

What is claimed is:

1. A work machine comprising:
a main frame defining a central longitudinal axis extending a fore-aft direction;
a first and second longitudinally extending track frame pivotally coupled to the main frame on opposing lateral sides of the main frame, wherein the pivotal movement of the first and second track frame relative to the main frame are generally transverse to the central longitudinal axis;
a crossbar extending between and substantially transverse to the first and second track frame, the crossbar including a mounting aperture extending in a substantially fore-aft direction;
a crossbar pin disposed within and extending through the mounting aperture;
an isolator assembly coupled to the crossbar pin, wherein the isolator assembly interconnects the crossbar and the crossbar pin;
wherein the isolator assembly includes an elastomeric isolator, and an actuator selectively controllable between a disengaged position, and an engaged position, attenuating a vibrations generated from a track frame movement.

2. The work machine of claim 1, wherein the crossbar is coupled with the main frame.

3. The work machine of claim 1, wherein the mounting aperture is enlarged sufficiently to enable a two to three degree rotation of the crossbar pin relative to the crossbar.

4. The work machine of claim 1, wherein the elastomeric isolator comprises a first pair of isolators positioned fore of the crossbar, the first pair of isolators coupled to opposing sides of the crossbar pin, and a second pair of isolators positioned aft of the crossbar, the second pair of isolators coupled to opposing sides of the crossbar pin.

5. The work machine of claim 1, wherein the actuator comprises:
a piston securely coupled to the elastomeric isolator;
a cylinder movably coupled to the piston and cooperating with the piston to create a pressurized chamber for a hydraulic fluid;
a fluid port for hydraulic fluid ingress and egress to a pressurized fluid line hydraulically coupled to an accumulator; and
a valve coupled to the fluid line and controllable to adjust a pressure in the pressurized chamber.

6. The work machine of claim 5, further comprising:
a controller including a processor and a memory having a dampening algorithm stored thereon, wherein the processor is operable to execute the dampening algorithm to:
receive a target ride cushioning setting signal from a user input interface; and
adjust the pressure in the pressurized chamber based on the target ride cushioning setting signal from the user input interface.

7. The work machine of claim 6 wherein the controller further adjusts the pressure in the pressurized chamber based on the pivotal movement of the track frame relative to the main frame.

8. The work machine of claim 6, further comprising:
a vibration sensor coupled to one of the main frame and the crossbar, wherein the controller further adjusts the pressure in the pressurized chamber based on a vibration output signal from the vibration sensor.

9. The work machine of claim 1, further comprising a first plate rigidly attached to the crossbar on a first side of the mounting aperture, and a second plate rigidly attached to the crossbar on a second side of the mounting aperture opposite the first plate.

10. The work machine of claim 9, wherein the elastomeric isolator is disposed between the first plate and the second plate.

11. The work machine of claim 10, wherein the hydraulic actuator is disposed adjacent an opposing side of the first plate relative to the elastomeric isolator.

12. The work machine of claim 9, wherein the first plate defines a piston aperture sized to receive a plunger portion of the piston therethrough, wherein the elastomeric isolator is coupled to the plunger portion of the piston.

13. The work machine of claim 12, wherein the piston includes a base portion sized larger than the piston aperture and configured to abut the first plate.

14. The work machine of claim 12, wherein each of the crossbar pin and the second plate defines a respective fastener opening, and further comprising a fastener including a head portion disposed adjacent the second plate, and a shank portion extending from the head portion through the fastener opening of the second plate, the fastener opening of the crossbar pin, the piston aperture of the first plate, and engaged with the cylinder portion of the actuator.

15. An isolator system for attenuating vibrations from a crossbar on work machine, the crossbar including a mounting aperture, the isolator system comprising:
a first plate rigidly attached to the crossbar on a first side of the mounting aperture;
a second plate rigidly attached to the crossbar on a second side of the mounting aperture opposite the first plate;
an elastomeric isolator disposed between the first plate and the second plate;
a crossbar pin disposed within and extending through the mounting aperture to couple the elastomeric isolator to the crossbar;
a hydraulic actuator disposed adjacent on opposing side of the first plate relative to the elastomeric isolator;
an accumulator hydraulically coupled to the hydraulic actuator; and
a controller including a processor and a memory having a dampening algorithm stored thereon, wherein the processor is operable to execute the dampening algorithm to selectively control engagement of the hydraulic actuator with the accumulator, attenuating a vibrations on a work machine.

16. The isolator system of claim 15, wherein the hydraulic actuator comprises:
a piston securely coupled to the elastomeric isolator;
a cylinder movably coupled to the piston and cooperating with the piston to create a pressurized chamber for a hydraulic fluid;
a fluid port for hydraulic fluid ingress and egress to a pressurized fluid line hydraulically coupled to an accumulator; and
a valve coupled to the fluid line and controllable to adjust a pressure in the pressurized chamber,
wherein the dampening algorithm further control the hydraulic actuator to adjust a pressure in the pressurized chamber.

17. The isolator system of claim 15, wherein the first plate defines a piston aperture sized to receive a plunger portion of the piston therethrough, wherein the elastomeric isolator is coupled to the plunger portion of the piston.

18. The isolator system of claim 15, wherein the piston includes a base portion sized larger than the piston aperture and configured to abut the first plate.

19. The isolator system of claim 15, wherein each of the crossbar pin and the second plate defines a respective fastener opening, and further comprising a fastener including a head portion disposed adjacent the second plate, and a shank portion extending from the head portion through the fastener opening of the second plate, the fastener opening of the crossbar pin, the piston aperture of the first plate, and engaged with the cylinder portion of the actuator.
